(19) United States
(12) Patent Application Publication
(10) Pub. No.: US 2004/0019459 A1
(43) Pub. Date: Jan. 29, 2004

(54) Auto-characterization of optical devices

(76) Inventors: Paul Dietz, Ottawa (CA); Zeliko Ribaric, Kanata (CA); Kenneth Mikolajek, Kanata (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/206,051

(22) Filed: Jul. 29, 2002

(51) Int. Cl. G06F 11/30

(52) U.S. Cl. 702/184

(57) ABSTRACT

A method and system for the automated collection and storage of calibration data over the entire spectral and power range of an optical functional system having an optical functional device and a device controller. The automatic calibration test set-up of the invention includes a laser source, an optical power controlling device, and an optical multimeter that are stepped over the entire operating range of the optical functional device. Measurements are taken at the input and output to the device, and at the input and output to the device controller. The test set-up is coupled to a calibration workstation which, in turn, can be coupled to the controller of the optical system. Since the controller is based on a digital microprocessor, it is straightforward to programme the controller to store data or to execute particular algorithms as required by a given operational configuration.

### FIELD OF THE INVENTION

The present invention relates generally to characterising optical functional devices. More particularly, the present invention relates to a calibration method to determine the operating characteristics of an optical function subsystem.

### BACKGROUND OF THE INVENTION

Optical functional devices are an essential component of optical systems. Signal loss and attenuation of signal strength are important considerations in designing an optical system whether that system serves a communications, computing, medical technology or some other function.

Fiber optic technology is well known and is used in a variety of communications networks. These networks often use long transmission lines that are subject to attenuation of the signal. To compensate for this reduced signal strength, optical functional devices, such as optical fiber amplifiers, are used b boost the signal, thereby allowing long-haul transmission.

Optical functional devices are formed of optical components, singly, or in combinations. These optical components include: erbium doped fiber amplifiers (EDFAs); Raman Amplifiers; semiconductor optical amplifiers (SOAs); erbium doped waveguide amplifiers (EDWAs); wideband optical amplifiers (WOAs); variable optical attenuators (VOAs); modulators; lasers; fiber lasers; laser arrays; micro-electrical mechanical systems (MEMS); tuneable lasers; optical switches; Dynamic Channel Equalizers; Differential Gain Equalizers; Optical Channel Monitors; Optical Performance Monitors; and tuneable filters. Combinations may include different components. The field of optical function systems is very broad; the following discussion uses one example of optical fiber amplifiers. A person skilled in the art will see that similarities are applicable to other optical function systems. An optical fiber amplifier, such as an EDFA, is a fiber that is doped with rare earth elements. The fiber requires a means for pumping (inducing population inversion in) the doped fiber atoms in order for the fiber to act as an amplifier. Amplification is limited to a gain band which ideally includes the wavelength of the input signal light. Depending on the doping technique used, the optical amplifier can operate in the 1300 nm or the 1670 nm data wavelength ranges. There can be a single laser pump or a plurality of laser pumps present in an amplifier system. When laser pump diode light is injected into the amplifier, some electrons in the rare earth atoms within the fiber are excited from a base level to a higher energy level. If the population of the higher energy level exceeds the lower energy level, the incoming data light causes a net return of atoms from their heightened energy state, to their base level, thereby generating a net stimulated light emission. Optical amplification is achieved as a result of this stimulated light emission process.

In order for an amplifying system to be self-characterizing, a calibration function is combined with the amplifier to measure the gain characteristics of the amplifier with varying levels of input data light. This capability can also be used to configure the amplifier in an automatic gain control mode if required. The optical amplifier system contains optical sensors, usually p-type/intrinsic/n-type (PIN) photodiodes. An ingoing PIN photodiode (through a power splitter) taps a proportion of optical power at the input. Similarly, an outgoing PIN photodiode senses the output of the amplifier in the same manner, by receiving a proportion of the output optical power. The tapped optical power received by these PIN photodiodes provides information on the gain characteristics of the amplifier. A controller is used in the optical amplifying system. The controller receives the gain-related data from the PIN photodiodes and determines the appropriate laser pump current needed to excite the rare earth atoms within the fiber to induce light emission and thereby amplify the signal.

During assembly and manufacture of an optical amplifier system, the responsivities of the PIN photodiodes are subject to both manufacturing variances and spreads associated with assembly (e.g. coupling tolerances). In fact, these PIN photodiodes can vary substantially from device to device by several orders of magnitude. These PIN photodiodes need to be calibrated to determine their “photon to current” response. Further, a full characterization of the amplifier system as a whole is required, in order to account for variances of the PIN photodiodes, the pump lasers, or of other devices used, over the entire operating range of the amplifier. This characterization includes (but is not limited to) parameters such as input power, output power, temperature, wavelengths, and any other measurements that influence the overall performance of the amplifier. Those skilled in the art are familiar with the manual calibration techniques commonly used for characterizing amplifier systems, back facet monitor photodiodes, or any other system requiring calibration of laser output to a measured signal. These calibration methods usually meet national or international standards such as the International Organization for Standardization (ISO) or International Electrotechnical Commission (IEC). For economic reasons, most devices under test are subjected to only a few standard measurements in order to meet minimum specifications. A technician or operator who is responsible for manually calibrating each device performs the measurements. Generally, the technician takes a number of power measurements at either a single wavelength or across several specific wavelengths. However, the actual calibration range performed on each device is usually very small as this is a time consuming process. Further, it is subject to human error.

Those skilled in the art are aware of a method to measure the noise and gain of an amplifier whereby the amplifier is configured as an oscillator by applying optical feedback with known loss. The output power at a given wavelength and the noise are measured with an optical spectrum analyser or with a set of filters and a power meter. This known method however, deals mostly with noise measurement and does not provide details to support a full characterization over the entire operating range of the amplifier gain or respective of other conditions (e.g. temperature, or other necessary parameters as listed above). Placing the amplifier into oscillation mode precludes the option of easily re-calibrating the device under test (DUT). This necessitates extra devices and components to be used with the DUT in order to carry out the characterization procedure described. Also known is a system for automatically characterizing the temperature dependence of a laser source and the use of the characterization data to control the operation of the laser at different operating temperatures. While this known system is a technique of automatic characterization, it is limited to monitoring the wavelength of a laser source.

What is needed are optical functional devices which are well-characterized, compensated, and ready for system insertion. Further, these compensated optical functional devices, ideally, include a built-in reference and are efficiently assembled from uncharacterized optical components, with a minimised risk of human error and a provision for in-service re-calibration or calibration adjustment capabilities. Those skilled in the art will appreciate that the same advantages described in this invention for individual functions would also apply, and in many cases with additional benefits, in situations where more than one functional device could be integrated together.

### SUMMARY OF THE INVENTION

It is an object of the present invention to obviate or mitigate at least one disadvantage of previous auto-characterization methods and systems. In particular, it is an object of the present invention to provide an integrated apparatus adapted for automatic characterization and calibration of optical functional devices. Such an apparatus allows a method of calibration that is an improvement in both time and accuracy in comparison to the prior art. Further, this apparatus requires little human intervention. Automating the calibration process increases the accuracy of the calibration results by allowing an increased number of calibration measurements to be taken, and by reducing the probability of human error.

In a first aspect, the present invention provides a method of calibrating an optical functional system where the system has an optical functional device and a feedback means. The feedback means include an optical functional device controller having an input and an output. The method comprises applying an input signal to the optical functional device over a range of input power levels. A corresponding output signal from the optical functional device is then detected at each of the input power levels. The input and output power levels at the controller are also detected at each of the input power levels. These steps are repeated for each of a plurality of input wavelengths. The combined measurements are used to determine optical functional system calibration data, which are then stored in a storage device for access by the controller. Preferably, the input power levels and input wavelengths cover the specified power and spectral operating ranges of the optical functional device.

Embodiments of the method include storing the calibration data as a table or as a polynomial. This data is stored for access by the controller and permits the device to self-calibrate, preferably dynamically, in response to operating conditions, such as temperature, or age. It is fully contemplated that the calibration data can be compressed in manners well known to those of skill in the art.

The present invention also provides an automated calibration system for an optical functional system. The system includes means for applying an input signal to an optical functional device over a predetermined range of input power levels and a predetermined range of wavelengths. The means for applying the signal can include, for example, a tuneable laser source and an optical attenuator. The system also includes means for detecting a corresponding output signal from the optical functional device at each of the power levels, and means for detecting power at the input and the output to the controller at each of the input power levels. Typically these levels are detected at an optical multimeter, and by the controller, and relayed to a calibration workstation. The calibration workstation includes means for determining optical functional device controller calibration data based on the input and output signals, and the measured input and output power at the controller, at each of the input power levels and predetermined wavelengths. The workstation generally includes means for communicating with a messaging unit in the controller, and can, thus, store the calibration data in a storage device for access by the controller.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a simplified schematic representation of an optical function and controller;

FIG. 2 is an algorithm of a preferred embodiment;

FIG. 3 is a graph of calibration results of the ingoing and outgoing PIN photodiodes of FIG. 1; and

FIG. 4 graphically illustrates an example of a current sweep at various input powers at a specific wavelength.

### DETAILED DESCRIPTION

Generally, the present invention provides a method and system for the automated collection and storage of calibration data over the entire spectral and power range of an optical functional system. The automatic calibration test set-up of the invention includes testing instruments: a laser source, an optical power controlling device, and an optical multimeter. These instruments are coupled to a calibration workstation which, in turn, is coupled to the controller of the optical system. Since the controller is based on a digital microprocessor, it is straightforward to programme the controller to store data or to execute particular algorithms as required by a given operational configuration.

In the case of an optical fiber amplifier, the optical wavelength and the optical power of the amplifier are set and the laser pump power is stepped through its operating range. The input and output power of the amplifier are measured by the external instruments. At the same time, the input and output power are measured by uncalibrated PIN photodiodes and are related via the controller to the external measurements made by the calibrated instruments. A significant advantage of this approach is that the photodiodes are calibrated in the context of their permanent connection to the amplifier (or other device) whose behaviour they are used to monitor. This removes the additional uncertainty and errors associated with coupling external measuring photodiodes for characterization prior to service introduction. In order to accommodate the dynamic range required for sensing the photodiode currents, the digital controller applies algorithms to dynamically adapt the sensitivities to the signal levels as needed, allowing for flexibility but reproducibility in both calibration and subsequent measurement.

A set of responses (in the form of characterization equations with coefficients and load information, or a look up table, etc.) is made based on the optical wavelength, optical input power and optical output power measurements. The data measured at the manufacturing stage is then stored in the controller for later use under operating conditions. An important advantage of this approach is that data compression algorithms and curve-fitting procedures (well-known to those skilled in the art) are used to enable large amounts of useful data to be economically stored in conjunction with the controller and the characterized device to be controlled.

An advantage to having the calibration data, sensitive to operating conditions, stored in the controller is that self calibration or health monitoring algorithms can be applied to the optical function system. These algorithms can address the issues of laser ageing, temperature change and change in response characteristics over time. Further, a history of any degradation may be stored in the memory of the controller and used for failure prediction or forwarded to a network management station for further analysis. Further the detectors calibrated remain permanently associated with the functional device and avoid connector loss that can be associated with external detectors. The increased accuracy of initial characterization forms the basis of improved self characterization of the system.

In a presently preferred embodiment, an EDFA is used. However, other types of optical functional devices, such as other types of optical amplifiers (including SOAs, Erbium doped waveguide amplifiers, Raman amplifiers), VOAs, MEMS, dynamic gain equalizer, modulators, lasers and laser arrays, fiber lasers, tuneable lasers, optical switches, or tuneable filters, can be used and remain within the scope of the invention. An automatic calibration test set-up includes instruments that will calibrate the amplifier and controller. The EDFA sensors are usually PIN photodiodes, used to measure optical power, and the control function is the drive current of the laser pump(s) used to energize the erbium in the amplifier. The testing equipment described in this embodiment are all standard, properly calibrated off-the-shelf instruments.

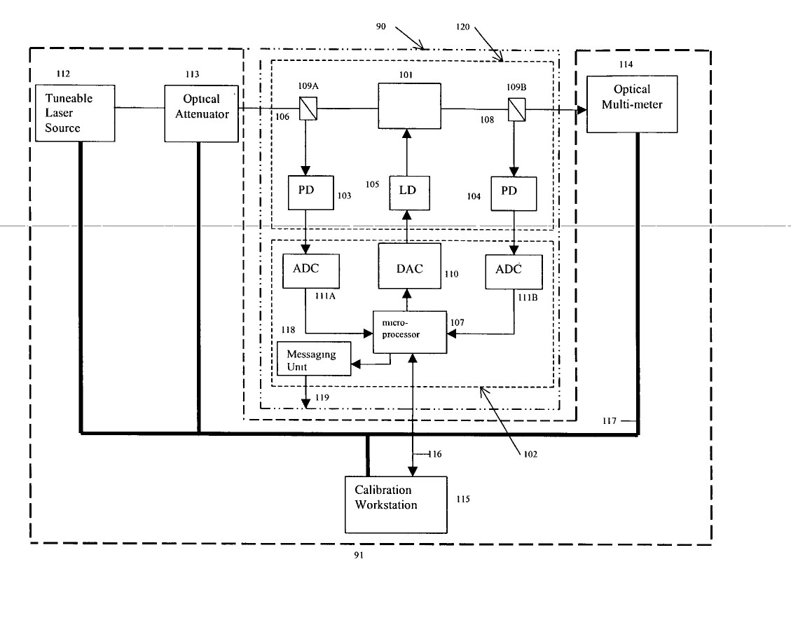

FIG. 1 illustrates the preferred embodiment of the present invention showing a known self-characterizing optical function subsystem 90, such as an optical amplifier, with the auto-calibration apparatus 91 of the present invention. The schematic is a simplified representation and only includes the functions necessary for illustrating the innovation.

The optical function system 90 includes an optical function subsystem 120 coupled to a controller 102; and to an output means 119. The optical function subsystem 120 includes an optical functional device such as an optical fiber amplifier 101; input 109A and output 109B splitters connected to the amplifier 101 and respectively to photodiodes 103 and 104; an optical input 106 coupled to splitter 109A and optical output 108 coupled to splitter 109B; and a corresponding laser pump 105.

The controller 102 includes an Analog to Digital Converter (ADC) 111A and 111B for respective coupling to the photodiodes 103 and 104; a Digital to Analog Converter (DAC) 110 for connecting to the laser pump 105 and a micro-processor 107 for connecting to the ADCs 111A, 111B, the DAC 110, and a messaging unit 118. The messaging unit 118 is in turn available to be coupled to the external network by messaging means 119.

The photodiodes 103, 104 controller 102 and laser pump 105 constitute a feedback means for the optical function. Those skilled in the art can understand that this embodiment could be applied to an optical amplifier system with multiple pumps or to multistage amplifier systems without departing from the scope of the invention. Those skilled in the art will realize that this can be applied to other optical functions.

The auto-calibration apparatus 91 includes: a laser source 112 (tuneable in the case of wavelength calibration), connected to an optical power controlling device such as an optical attenuator 113; an optical multi-meter 114; a calibration workstation 115; an IEEE-488 bus 117 connecting the above test functions, and an RS-232 serial interface connection 116 for coupling the calibration workstation 115 to the controller 102. It is understood that different models or different types of testing equipment can be used and remain within the scope of the invention.

The IEEE-488 117 and RS-232 bus 116 architectures are used in this embodiment, however, one skilled in the art will understand that different bus standards can be used while remaining within the scope of the invention.

In operation, the optical amplifier 101 provides a specified gain band to include that wavelength input to the optical input 106 by the auto-calibrator 91. Specifically, the system contains at least one laser pump diode 105 used to excite the erbium in the amplifier 101, an ingoing PIN photodiode 103 to measure the input power to the amplifier, and an outgoing PIN photodiode 104 to measure the output power from the amplifier. A proportion of optical power is tapped from the input of the amplifier by splitter 109A. The tapped optical power is received by the ingoing PIN photodiode 103. Similarly, a proportion of optical power is tapped from the output of the amplifier by splitter 109B, and is received by the outgoing PIN photodiode 104. The tapped optical power received by each of the PIN photodiodes 103 and 104 provides the input and output power measurements needed for the controller 102 to regulate the current to the laser pump 105. For example in a case where measurements of input and output photodiodes show that the amplifier gain is greater than presently called for, then the current applied to the pump laser can be incrementally reduced until the output power is adjusted to the required level. Those skilled in the art will realize that this adjustment can be achieved by a variety of approaches, for example: decrement current, review new gain level, repeat until new gain achieved. The PIN photodiodes 103, 104 must be calibrated in order to determine their operational characteristics when paired with the amplifier under test.

In order to accurately characterize an optical function (such as an EDFA) with its associated controller, it is necessary to first calibrate the optical testing equipment to be used. In order to do this, the laser source 112 is connected to the optical attenuator 113. During calibration of the EDFA, the attenuator is connected to the input of the EDFA 101. However, the EDFA is bypassed initially, in order to perform a calibration of the test equipment. The attenuator 113 is connected directly to the optical multi-meter 114 and a calibration of the test equipment is performed. Those skilled in the art will appreciate that calibration of test equipment is well known.

The calibration workstation 115 interfaces with the test instrumentation through the IEEE-488 bus 117, and in turn, interfaces with the EDFA controller 102 through the RS-232 connection 116. The test instruments 112, 113 and 114 are controlled by the calibration workstation 115 using control and interface software known in the art, such as LABVIEW. The auto-calibration test set-up is connected to the EDFA amplifier circuitry in order to take measurements. The laser current, as determined by the controller 102 is read by interfacing with the controller 102 through the RS-232 bus 116. The tuneable laser source 112 is the means for selecting and setting the input wavelength. The attenuator 113 is varied and supplies a range of optical power to the amplifier 101. The amplified signals are then output to the optical multi-meter 114.

A photo-current measurement is also taken at the ingoing PIN photodiode 103. A conversion from current to an analog voltage is performed by circuitry (not shown) in the controller 102. The ADC 111A receives the analog voltage and converts it to a digital signal, which is sent on the RS232 bus 116 to the calibration workstation 115. The outgoing PIN photodiode 104 is also measured, in the same manner.

The input wavelength is set by the laser source 112 and the attenuator 113 is varied to allow a full range of the input power levels. This input power range represents the stated operating range of the amplifier 101 under test. At each power level, the current to the pump laser 105 is stepped from its minimum current level to its maximum current level in increments of, for example, 10 mA. Those skilled in the art will understand that different current level increments can be used. At each current setting, external measurements of the output power are made using the optical multi-meter 114.

This is then repeated for another wavelength such that a series of measurements are taken including; the input power set by the attenuator 113 the measured input power of the ingoing PIN photodiode 103 the output power of the outgoing PIN photodiode 104, the laser pump 105, and the output of the amplifier as received by the optical multimeter 114. A graph similar to that shown in FIG. 4 is generated. Those skilled in the art may make simple modifications to measure additional parameters. The measurements are taken at each wavelength, stepped across the operating range in increments (e.g. 10 nm). Those skilled in the art will understand that this approach can also be used for measurements at a single wavelength.

The results indicate the responses of the device under a range of operating conditions, in other words, how the optical function 101, PIN photodiodes 103 and 104, laser pump 105 and controller 102 as a whole will behave in operational use. In the preferred embodiment the messaging unit 118 in the controller 102 is capable of transmitting and receiving data and instructions. However, other embodiments with limited communication capability, possibly to minimize costs, are also possible and remain within the scope of the invention. In the preferred embodiment the optical function 101 and controller 102 are calibrated together and remain as a unit. However, other embodiments, in which one controller is used to calibrate several optical functional elements with low variation levels, are also possible and remain within the scope of the invention.

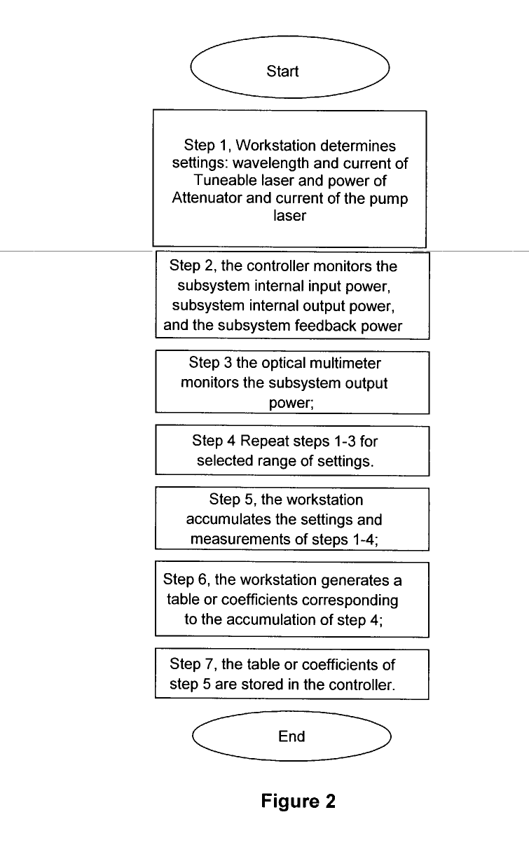

FIG. 2 shows the algorithm employed in the auto calibration process: Step 1, the calibration workstation 115, determines the settings (wavelength and current of the laser 112, current of the pump laser 105 and the power of the optical attenuator 113); Step 2, the controller 107 monitors the subsystem internal input power and subsystem internal output power from the ADCs (111A and 111B respectively) and the subsystem feedback power to the DAC 110; Step 3 the optical multimeter 114 monitors the subsystem output power; Step 4 Repeat steps 1-3 for selected range of settings; Step 5, the workstation 115 accumulates the settings and measurements of steps 1-4 (calibration data); Step 6, the workstation 115 generates a table or coefficients corresponding to the calibration data accumulated at step 4; Step 7, the table or coefficients of step 5 are stored in the controller 107.

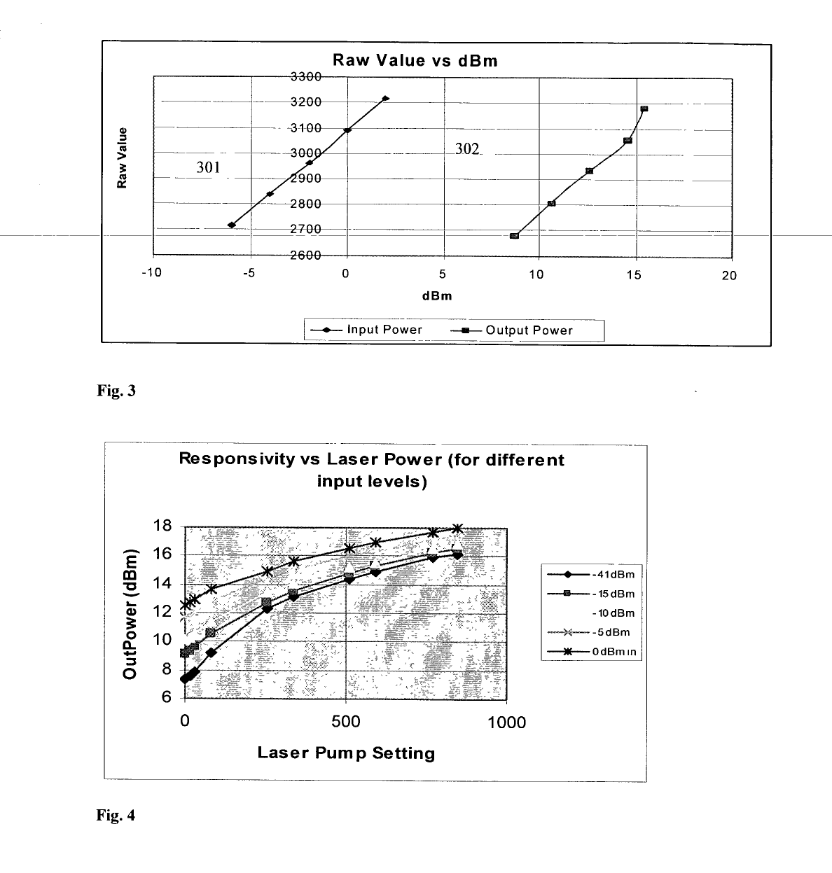

FIG. 3 is a graph of calibration results of the ingoing and outgoing PIN photodiode of FIG. 1. The left hand graphical representation 301 is the magnitude of light measured (Raw Value vs. dBm) at the ingoing PIN photodiode 103 and similarly, the right hand graphical representation 302 is the magnitude of light measured (Raw Value vs. dBm) at the outgoing PIN photodiode 104.

The calibration data ideally substantially covers the entire spectral and power range of the amplifier, plus any other variables useful for generating response characteristics for maintenance or self re-calibration. FIG. 4 represents a current sweep at various input powers at a given wavelength. A table of calibration results is generated and stored in the controller 107 in the form of look-up tables or equations with coefficients. The data can be stored in a polynomial using a curve-fitting algorithm which is well known to those skilled in the art.

An advantage to having the calibration data sensitive to operating conditions (age, temperature, etc.) stored in the controller is that self calibration or health monitoring algorithms can be applied to the optical function system. These algorithms can address the issues of laser aging, temperature change and change in response characteristics over time. Further, a history of any degradation may be stored in the memory of the controller (or communicated via 118 to a network management station) and used for failure prediction.

In the case of rare-earth doped fiber amplifiers, Raman amplifiers, or any other laser driven optical function system, the pump laser diode might degrade in efficiency towards the end of it's life relative to when it was manufactured. Degradation can also be observed in devices based on the same operating principle, such as SOAs (Semiconductor Optical Amplifiers). This degradation may be detected and compensated for by applying more pump current to obtain the same laser light output. The controller will compare the requested drive currents with the stored, permissible range and (via the messaging interface) raise an alarm if excessive compensation is being requested.

Controllers that can self-calibrate while in service (operational) can adjust their initial calibration values based on changing conditions. For example, light detector responsivity such as in the case of PIN photodiodes, may be affected by temperature, bias voltages and possibly by aging. In one example, the performance of optical functional devices may be affected by age. The age of such devices may be detected by such chronometers known in the art and convenient for incorporation in the subsystem. The detected age may then be used to select different information from an incorporated lookup table or provide different input to a coefficient formula. Such information may be based on statistical or historical data, and could be based on specific transmitted calibration signals or on live data traffic of known amplitude. This allows the controller to adjust the feedback (and gain) with sensitivity to age.

While the above embodiment details an auto-calibration technique for an optical function system such as an Erbium-doped optical amplifier, it will be understood by those skilled in the art, that this invention is not limited to this one application. Other optical function systems such as, other types of optical amplifier (SOAs, Raman, EDWAs etc), MEMS, dynamic gain equalizer, VOAs, modulators, lasers and laser arrays, tuneable lasers, fiber lasers, optical switches and tuneable filters can also benefit from this autocalibration technique. Dynamic Gain Equalizers, which can have as many as 40 channels, are also calibrated with the input light characteristics obtained on a per wavelength basis. The wavelength, input power, noise floor and polarization can be changed and measured automatically for a complete system calibration. Further, the self-characterization techniques are not limited to temperature, but to those operating conditions that can be detected.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of calibrating an optical functional system, the system having an optical functional device and a feedback means, the feedback means including an input, an output and an optical functional device controller, the method comprising:
(a) applying an input signal to the optical functional device over a range of input power levels;
(b) detecting a corresponding output signal from the optical functional device at each of the power levels;
(c) detecting power at the input and the output to the controller at each of the input power levels;
(c) repeating steps (a) to (c) for a plurality of input wavelengths;
(d) determining optical functional device calibration data based on the input and output signals, and the measured input and output power at the controller;
(e) storing the calibration data in a storage device for access by the controller.

2. The method of claim 1, wherein the input power levels substantially cover a specified power range of the optical functional device.

3. The method of claim 1, wherein the input wavelengths substantially cover a specified spectral range for the optical functional device.

4. The method of claim 1, wherein the calibration data is stored as a table.

5. The method of claim 1, wherein the calibration data is stored as a polynomial equation.

6. The method of claim 1, wherein the calibration data is compressed for storage.

7. The method of claim 1, further including calibrating the optical functional device in response to operating conditions and the calibration data.

8. The method of claim 1, further comprising dynamically controlling the optical functional device in accordance with the stored correction data.

9. A automated calibration system for an optical functional system, the optical functional system having an optical functional device and a feedback means, the feedback means including an input, an output and an optical functional device controller, the calibration system comprising:
means for applying an input signal to the optical functional device over a predetermined range of input power levels and a predetermined range of wavelengths;
means for detecting a corresponding output signal from the optical functional device at each of the power levels;
means for detecting power at the input and the output to the controller at each of the input power levels;
means for determining optical functional device controller calibration data based on the input and output signals, and the measured input and output power at the controller, at each of the input power levels and predetermined wavelengths; and
means for storing the calibration data in a storage device for access by the controller.

10. The calibration system of claim 9, wherein the means for applying the input signal includes a tuneable laser source.

11. The calibration system of claim 9, wherein the means for applying the input signal includes an optical attenuator.

12. The calibration system of claim 9, wherein the means for detecting the corresponding output signal includes an optical multimeter.

13. The calibration system of claim 9, further including a calibration workstation for controlling the application of the input power levels and wavelengths.

14. The calibration system of claim 13, wherein the controller includes a messaging unit for communicating with the calibration workstation.

15. The calibration system of claim 14, wherein the calibration data is transmitted to the means for storage via the messaging unit.

16. The calibration system of claim 9, wherein the controller includes a messaging unit for communicating with a network.
